(19) United States
(12) Patent Application Publication
(10) Pub. No.: US 2016/0087511 A1
(43) Pub. Date: Mar. 24, 2016

(54) ELECTRICAL MACHINE

(71) Applicant: SPAL AUTOMOTIVE S.r.l, Correggio ( Reggio Emilia) (IT)

(72) Inventor: Pietro DE FILIPPIS, Varazze (Savona) (IT)

(21) Appl. No.: 14/892,605

(22) PCT Filed: May 26, 2014
(86) PCT No.: PCT/IB2014/061714

§ 371 Date: Nov. 20, 2015

(30) Foreign Application Priority Data
May 29, 2013 (IT) BO2013A000271

(51) Int. Cl. H02K 11/00

(52) U.S. Cl. CPC H02K 11/0073

(57) ABSTRACT

An electrical machine that includes an electronic module including a plurality of electronic components, an electronic module supporting element and a heat sink for dispersing the heat produced by the electronic module; at least a first electronic component amongst the electronic components of the electronic module is facing towards the heat sink and in thermal contact with it and the electrical machine includes a spring acting between the supporting element and the first electronic component for pushing it away from the supporting element towards the heat sink.

### TECHNICAL FIELD

This invention relates to a rotary electrical machine with reference in particular to the integrated electronic control module.

### BACKGROUND ART

In general, a reference known type of rotary electrical machine comprises a casing having inside a stator, rigidly constrained to the casing, and a rotor, for example with permanent magnets, rotatably constrained to the casing.

An electronic module or control electronics, connected to the stator, comprises, schematically, a printed circuit, a plurality of conductor tracks and electronic power components, both of the SMD (Surface Mount Device) type and the PTH (Pin Through Hole) type, which are positioned on the printed circuit and connected to it and/or to the conductor tracks.

A cap closes the casing to form a closed container from which connection terminals protrude for the power supply of the control electronics.

The electrical machines used as a reference for this invention are of the enclosed type known in particular as the sealed type, that is, sealed electrical machines.

One of the principle difficulties of the sealed type of electrical machine is the dispersal of the heat produced by the electronic module during operation of the electrical machine.

A solution designed to overcome this difficulty is described in the document WO20133008180 in the name of the same Applicant.

In this solution the cap of the electrical machine forms a heat sink for dispersing the heat produced by the electronic module.

The power electronic components are positioned on the same side of the printed circuit, below and opposite the cap, in such a way that they can be placed in contact with the cap to optimise the heat dispersal.

A thermally conductive paste is preferably interposed between the electronic components and the cap, which as indicated above acts as a heat sink, so as to maximise the heat exchange between the electronic components and the heat sink.

In fact, the printed circuit, in particular, retains its integrity up to a predetermined temperature value.

Despite the measures adopted in the prior art solutions, dispersal of the heat produced by the power electronic components, in particular those of the PTH type, is still not really optimal.

The geometry of several PTH components, for example the electrolytic capacitors, usually present in the electronic module, requires a relatively large quantity of thermally conductive paste to find an effective heat exchange between said components and the heat sink.

The heat dispersal is also affected by the electrical machine construction and assembly tolerances which determine the quality of the coupling between the electronic components and the heat sink.

### DISCLOSURE OF THE INVENTION

In this context, the main aim of this invention is to overcome the above-mentioned disadvantages.

One aim of this invention is to provide an electrical machine in which the cooling of the power electronic components, in particular those of the PTH type, is further improved compared with prior art solutions.

A further aim is to provide an electrical machine in which there is a reduced quantity of thermally conductive paste interposed between the power electronic components, in particular those of the PTH type, and the heat sink.

Another aim of this invention is to provide an electrical machine in which the heat dispersal is less influenced by the construction tolerances compared with the prior art solutions.

The technical purpose indicated and the aims specified are substantially achieved by an electrical machine according to claim 1.

### BRIEF DESCRIPTION OF DRAWINGS

Further features and advantages of this invention are more apparent in the detailed description below, with reference to a non-limiting and non-exclusive preferred embodiment of an electrical machine, as illustrated in the accompanying drawings, in which:

FIG. 1 is a schematic partly exploded perspective view, with some parts cut away for greater clarity, of an electrical machine according to this invention;

FIG. 2 is a schematic partly exploded perspective view of a detail of the electrical machine of FIG. 1;

FIG. 3 is a schematic cross-section of the electrical machine of FIG. 1 with some parts cut away for greater clarity.

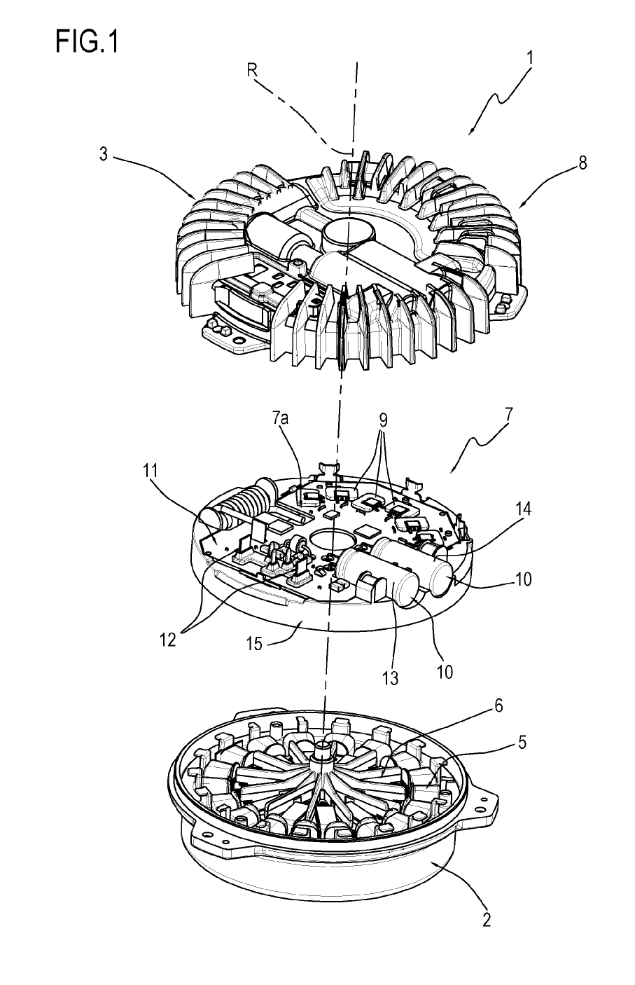

With reference in particular to FIG. 1, the numeral 1 denotes a rotary electrical machine according to this invention.

### DETAILED DESCRIPTION OF PREFERRED EMBODIMENTS OF THE INVENTION

The machine 1 is preferably a brushless motor of a substantially known type and is hereinafter described only relative to the parts necessary for understanding this invention.

The machine 1 in the preferred embodiment is an electric motor of the sealed type, that is, without any openings for access to the inside, to which express reference will hereinafter be made but without thereby limiting the scope of the invention.

The machine 1 comprises a casing 2 and a cap 3 for closing the casing 2 to form, with the casing 2, a case or closed container 4.

The electrical machine 1 comprises a stator 5, for example of the wound type, constrained to the casing 2 and a rotor 6 inserted in the case 4 and constrained to the case rotatably about an axis R of rotation.

The electrical machine 1 comprises an electronic module 7, inserted at least partly in the casing 2, for supplying the stator 5.

The electrical machine 1 also comprises a heat sink 8 for dispersing the heat produced inside the case 4.

In the preferred embodiment illustrated, the heat sink 8 is formed by the cap 3 for closing the casing 2.

In use, the machine 2 is preferably assembled in such a way that the electronic module 7 can effectively exchange heat with the cap 3 which also disperses that heat to the outside of the casing 2.

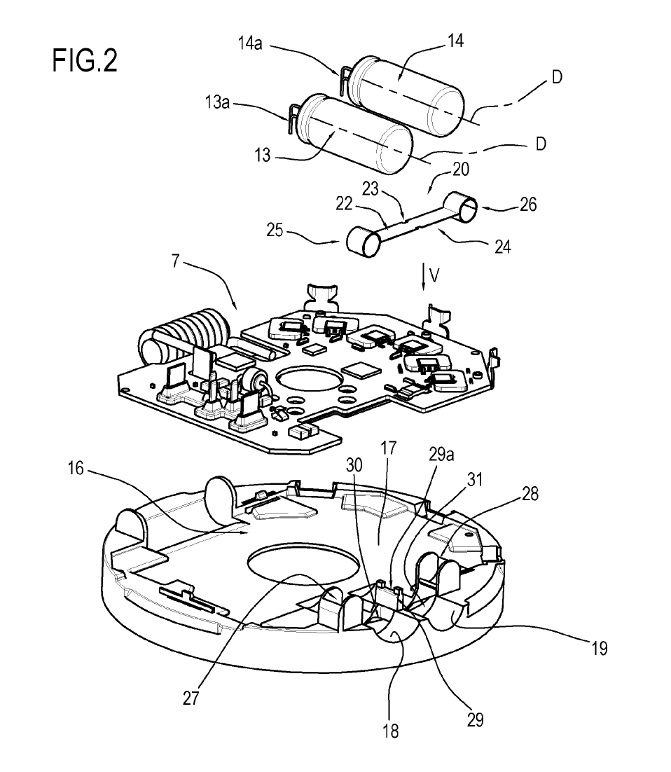

As illustrated in particular in FIGS. 1 and 2, the electronic module 7 comprises a plurality of electronic components.

In the preferred embodiment illustrated, standing out amongst the electronic components, in particular, there are surface mount electronic components 9, also known as “SMD” electronic components, and pin through hole mount electronic components 10, also known as “PTH” electronic components.

In the preferred embodiment illustrated, the electronic module 7 of the electrical machine 1 comprises a printed circuit board 11, substantially known as a “PCB” or “Printed Circuit Board”.

The electronic components 9 and 10 are positioned on the same side 7a of the electronic module 7. In particular in they are positioned on the same side of the printed circuit board 11.

More precisely, the electronic components 9, 10 are positioned on the side 7a of the electronic module 7 so that they face towards the cap 3 and are opposite it.

In the embodiment illustrated, the electronic module 7 also comprises a plurality of conductor tracks 12, only partly illustrated, which implement the direct connections between the surface mount electronic components 9 and the “pin through hole” mount electronic components 10.

The conductor tracks 12 are preferably positioned on a second side 7b of the electronic module 7 which is opposite to the first side 7a.

A preferred example assembly of the electronic module 7 inside the machine 1 is described and illustrated in the document WO20133008180 by the same Applicant.

As illustrated, the PTH electronic components 10 comprise a first electrolytic capacitor 13 and a second electrolytic capacitor 14 which are connected in parallel, both facing towards the heat sink 8 formed by the cap 3.

More precisely, the capacitors 13, 14 are substantially cylindrical and comprise an outer cylindrical surface facing towards the heat sink 8.

In the preferred embodiment illustrated, the electronic components 13, 14 have a main line of extension D which is transversal to the axis R of rotation.

The capacitors 13, 14 are power components and therefore subject to heating during operation of the machine 1. Therefore, advantageously, they are brought into contact with the cap 3 for dissipating the heat that they produce, as described in more detail below.

The machine 1 comprises an electronic module 7 supporting element 15.

The supporting element 15 is preferably disk-shaped and is made of plastic material.

With particular reference to FIG. 2, it may be seen how the element 15 comprises a seat 16 for the electronic module 7 which is housed in the supporting element 15.

In particular, the seat 16 is shaped to receive the printed circuit board 11 and the electronic components whose dimensions in plan view extend beyond those of the printed circuit board 11.

Preferably, the seat 16 comprises a housing 17 for the printed circuit board 11.

Preferably, the seat 16 comprises a housing 18 for the capacitor 13.

Preferably, the seat 16 comprises a housing 19 for the capacitor 14.

According to this invention, the electrical machine 1 comprises elastic pushing means acting between the supporting means and the capacitors 13 and 14 for pushing them away from the supporting element 15 and from the printed circuit board 11 towards the heat sink 8.

In use, at least a first electronic component 13, 14 amongst the electronic components 9, 10 of the electronic module 7 is facing towards the heat sink 8 and is in thermal contact with it.

The electrical machine 1 comprises elastic pushing means acting between the electronic component 9, 10 supporting means and said first electronic component 13, 14 for pushing it away from the supporting means towards the heat sink 8.

The above-mentioned supporting means comprise electrical connection means, preferably comprising the printed circuit board 11 and if necessary the conductor tracks 12, acting between the electronic components 9, 10 to create the electronic module 7.

The electronic components 9, 10 are connected to the electrical connection means and the elastic pushing means preferably act between the electrical connection means and at least the capacitor 13.

Preferably, as indicated, the electrical connection means comprise the printed circuit board 11 and, in an embodiment not illustrated, the elastic pushing means act between the printed circuit board 11 and the capacitors 13, 14.

In the preferred embodiment illustrated, the supporting means comprise the supporting element 15 of the electronic module 7 and the elastic pushing means act between the supporting element 15 and the capacitors 13, 14.

Preferably, the elastic pushing means are located in the housing 18 of the capacitor 13 and in the housing 19 of the capacitor 14.

In the preferred embodiment illustrated, the elastic pushing means comprise a spring 20 acting on the capacitor 13.

Advantageously, the spring 20 also acts on the second capacitor 14, pushing it towards the heat sink 8.

Preferably, the spring 20 is of the constant pressure type for effectively holding the capacitors 13, 14 in contact with the cap 3.

To optimise the heat exchange between the electronic components 13, 14 and the heat sink 8, the machine 1 comprises thermally conductive means interposed between the components 13, 14 and the heat sink 8.

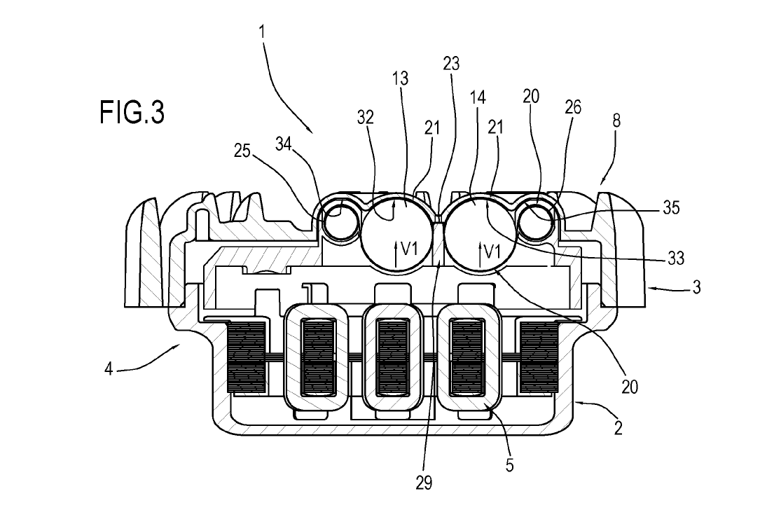

With reference to FIG. 3, it can be seen how the machine 1 comprises, for example, a thermally conductive paste 21, in particular of the type known as “thermally conductive gap filler” positioned between the capacitors 13, 14 and the cap 3.

The paste 21 creates a “preferred” transfer route for the heat dissipated from the electronic components 13, 14 towards the cap 3.

Thanks to the presence of the spring 20, the space between the components 13, 14 is extremely limited compared with prior art solutions and, advantageously, the quantity of paste 21 needed to optimise the heat exchange surfaces is significantly reduced.

In particular with reference to FIGS. 2 and 3, it can be seen how the spring 20 is formed by a suitably shaped piece of metal tape.

The spring 20 has a central portion 22, 23, 24 and two end portions 25, 26.

The end portions 25, 26 are curled, that is to say, they have a spiral shape or are wound in a spiral and are used for the coupling with the supporting element 15.

In particular, the supporting element 15 comprises a seat 27 for the end portion 25 and a seat 28 for the end portion 26 of the spring 20.

The seats 27 and 28 are preferably made in protrusions of the supporting element 15 which extend parallel with the machine 1 axis R of rotation.

The central portion comprises a first stretch 22 intended for engaging with the capacitor 13 and a second stretch 24 intended for engaging with the capacitor 14.

The first stretch 22 is intended to make contact with the electronic component 13 and applies on the latter a pushing action towards the heat sink 8. As already indicated, that pushing action is preferably constant.

The second stretch 24 is intended to make contact with the electronic component 14 and applies on the latter a pushing action towards the heat sink 8. As already indicated, that pushing action is preferably constant.

The central portion comprises a connecting stretch 23, preferably straight, which connects the first and second stretches 22, 24.

In the preferred embodiment illustrated, the stretch 23 has a transversal dimension which is less than the transversal dimension of the portions 22e 24.

In particular with reference to FIG. 2, it can be seen how the central portion of the spring 20, formed by the stretches 22, 23, 24, extends in a substantially straight line fashion.

More precisely, considering the spring 20 removed from the motor 1, the central portion of it is substantially straight.

The supporting element 15 comprises a separator 29 for separating the above-mentioned housings 18, 19.

Advantageously, the separator 29 forms a support or stop for the connecting stretch 23 of the spring 20.

Preferably, the separator 29 comprises a seat 29a for the stretch 23 of the spring 20.

As illustrated, the housings 18, 19 for the electronic components 13, 14 comprise, respectively, a seat 30 and a seat 31 for the first stretch 22 of the spring 20 and for the second stretch 24 of the spring 20.

In particular with reference to FIG. 3, it may be seen how, once the machine 1 is closed, the capacitors 13 and 14, pushed by the cap 3, respectively push the stretches 22 and 24 into the corresponding seats 30, 31.

In that way, the stretches 22 and 24 take on a curved shape even thanks to part of the metal tape which is unwound from the curled portions 25 and 26.

In other words, the stretches 22 and 24 of the spring 20, which are straight in the home position, that is to say, when not assembled in the electrical machine 1, take on a curved shape once the capacitors 13, 14 force them into the respective seats 30, 31.

In the preferred embodiment illustrated, the seats 30 and 31 are in the form of holes in the supporting element 15 in which the stretches 22 and 24 of the spring 20 are placed.

In use, the spring 20 is positioned in the housing 18, 19 with the end portion 25 in the seat 27 and the end portion 26 in the seat 28.

The stretch 22 is placed in the seat 30 and the stretch 24 is placed in the seat

Once the electronic components 13, 14 are inserted in the respective housings 18, 19, above the spring 20, the stretches 22 and 24 of the spring 20 are pushed in the direction V, unwinding at least part of the end portions 25, 26 and taking on a curved shape.

With reference to FIG. 3 it can be seen how, once the case 4 is closed, the portions 25, 26, as indicated, tend to curl up to allow the stretches 22, 24 to again adopt a straight shape, respectively applying to the electronic components 13, 14 a pushing action in the direction V1 against the heat sink 8, thereby optimising the heat exchange between the electronic components 13, 14 and the cap 3.

The stretches 22 and 24 in the straight configuration have a length which is less than the corresponding stretches 22 and 24 in the curved configuration. However, for the sake of simplicity the same reference character was used.

In the preferred embodiment illustrated, the capacitors 13, 14, which, as already indicated, are PTH type components, comprise respective rheophores 13a, 14a for connection to the printed circuit board 11.

Therefore, the capacitors 13, 14 are connected to the printed circuit board 11 by means of the rheophores 13a, 14a and are positioned in the housings 17, 18 in the supporting element 15.

The movement of the capacitors 13, 14 towards the cap 3 is preferably made possible thanks to the flexibility of the rheophores 13a, 14a.

Moreover, preferably, to further optimise the heat exchange surfaces between the electronic components 13, 14 and the heat sink 8, in particular with the cap 3, the latter has a profile which is substantially shaped to match the capacitors 13, 14, that is to say, it has related seats 32, 33 in which the capacitors 13, 14 are at least partly housed.

The cap 3 also comprises two inner concavities 34, 35 intended to receive the above-mentioned protrusions of the supporting element 15 in which the seats 27, 28 for the end portions 25, 26 of the spring 20 are made.

1. A rotary electrical machine, having its own axis of rotation, comprising an electronic module comprising a plurality of electronic components; supporting means for the electronic components; a heat sink for dispersing the heat produced by the electronic module; at least a first electronic component amongst the electronic components which is facing towards the heat sink and is in thermal contact with it; said electrical machine being characterised in that it comprises elastic pushing means acting between the supporting means and said first electronic component for pushing said first electronic component away from said supporting means towards said heat sink.

2. The electrical machine according to claim 1, wherein it comprises thermally conductive means interposed between said first electronic component and said heat sink.

3. The electrical machine according to claim 1, wherein said supporting means comprise electrical connection means acting between said electronic components for creating said electronic module, said electronic components being connected to said electrical connection means, said elastic pushing means acting between said electrical connection means and said first electronic component.

4. The electrical machine according to claim 3, wherein said electrical connection means comprise a printed circuit board, said elastic pushing means acting between said printed circuit board and said first electronic component.

5. The electrical machine according to claim 1, wherein said supporting means comprise a supporting element of said electronic module, said elastic pushing means acting between said supporting element and said first electronic component.

6. The electrical machine according to claim 5, wherein said supporting element comprises a housing for said first electronic component, said elastic pushing means acting between said housing and said first electronic component.

7. The electrical machine according to claim 1, wherein said supporting means comprise a seat for said elastic pushing means.

8. The electrical machine according to claim wherein said elastic pushing means comprise a constant pressure spring acting on said first electronic component.

9. The electrical machine according to claim 1, wherein said first electronic component is a power electronic component, in particular an electrolytic capacitor.

10. The electrical machine according to claim 1, wherein said electronic components comprise a second electronic component facing towards the heat sink and in thermal contact with it, said elastic pushing means acting between said supporting means and said second electronic component for pushing said second electronic component away from said supporting means towards said heat sink, said elastic means comprising a spring for pushing said first electronic component and said second electronic component.

11. The electrical machine according to claim 10, wherein said first electronic component is connected in parallel to said second electronic component.

12. The electrical machine according to claim 1, wherein said elastic pushing means comprise a spring acting at least on said first electronic component, said spring being formed by a metal tape and comprising at least a first stretch intended for engaging with said first electronic component and at least an end portion wound in a spiral, said supporting means comprising a seat for said end portion.

13. The electrical machine according to claim 1 wherein said first electronic component has a main line of extension which is transversal to said axis of rotation.
